(19) United States
(12) Patent Application Publication
(10) Pub. No.: US 2010/0023786 A1
(43) Pub. Date: Jan. 28, 2010

(54) SYSTEM AND METHOD FOR REDUCTION OF ELECTRICITY PRODUCTION AND DEMAND

(76) Inventor: Izidor LIBERMAN, Tel Mond (IL)

Correspondence Address: Pearl Cohen Zedek Latzer, LLP, 1500 Broadway, 12th Floor, New York, NY, 10036, US

(21) Appl. No.: 12/178,763

(22) Filed: Jul. 24, 2008

(51) Int. Cl. G06F 1/26

(52) U.S. Cl. 713/320

(57) ABSTRACT

A system and method of intermittently reducing power demand loads to postpone an activation of an incremental power supply source or hasten the deactivation of a power source.

### FIELD OF THE INVENTION

The present invention relates generally to managing reductions in electricity demand on an electrical power network

### BACKGROUND OF THE INVENTION

Electricity supply networks may meet periodic increases in electricity capacity by incrementally activating successive generators to meet the expected demand. A generator may be activated, for example, once demand for power has reached a particular threshold, and in general, generators are activated in anticipation of a future demand so that shortfalls of power generation are avoided. Activation of a generator may be an extremely costly process as it may entail heating larger quantities of water for steam production. Once a generator is activated, the power producer has an interest in selling all or the maximum amount of power from such activated generator. There is therefore an incentive for power producers on the one hand to avoid activating a generator, but on the other hand to maximize the sale of power from such generator once it has been activated.

Manually activated systems for activating power demand reduction measures are haphazard and uncoordinated; and frequently result in the unnecessary imposition of reduction measures and the continuation of such reduction measures in the face of excess power supply.

### SUMMARY OF THE INVENTION

Some embodiments of the invention may include a method of altering a sum of power demanded on an electrical network, where such method includes accepting a power supply threshold of an electrical network in a period, accepting a total power demand value of the electrical network in the period, selecting a first group of power demand sources from which to reduce power demand in the first portion of the period, selecting a second group of power demand sources from which to reduce power demand in a second portion of the period, so that the total reduction in power demand that is achieved from the reducing efforts in both the first portion of the period and in the second portion of the period is sufficient to prevent the total power demand value from crossing the power supply threshold during the first portion of the period and during the second portion of the period.

In some embodiments a method may include predicting a total power demand value for the period.

In some embodiments the predicting of demand may include measuring a change in power demand at a plurality of times during a period prior to the relevant period.

In some embodiments the accepting of the power supply threshold may include accepting a threshold for activating an additional power supply, and the method may include issuing a signal to cease the power demand reductions upon activation of the additional power supply.

Some embodiments may include accepting a threshold for deactivating a power supply source.

In some embodiments a method may include preventing a reduction in demand from a power demand source from which an override signal has been received.

In some embodiments a method may include issuing a signal to override the override signal upon the satisfaction of a pre-defined condition, such as an emergency override condition.

In some embodiments a method may include displaying to a user a cost of preventing of the power reduction process from one or more power demand sources.

In some embodiments a method may include issuing a first signal to a remote processor to reduce power demand in the first portion of the first period, and issuing a second signal from the remote processor to a group of other remote processors to reduce power demand in the first period.

In some embodiments a method may include issuing a signal to a load control unit associated with a power demand source.

Some embodiments of the invention may include simulating a group of demand sources upon which to activate a power reduction process on the basis of the effectiveness of the reduction on such sources and the reduction capacity of such sources as being sufficient to keep power demand within the threshold.

Some embodiments of the invention may include a method that includes calculating a reduction value of power demand that is sufficient to prevent the power demand from exceeding a power supply threshold in a period, designating a group of demand sources that are suitable for power demand reduction, issuing a signal to reduce power demand from a first group of the demand sources during a first part of the relevant period, and issuing a signal to reduce power demand from a second group of power demand sources during a second part of the relevant period, so that during the entire relevant period the reduced power demand is at least equal to the reduction value.

Some embodiments may include predicting the demand value for at least one part of the relevant period.

Some embodiments may include receiving at a first remote processor a signal to reduce power demand from a group of power demand sources, and issuing a signal to a second remote processor and to a third remote processor, where the second remote processor contacts a fourth remote processor that is associated with a group of demand sources, and where the third remote processor is associated with another group of demand sources, so that a chain of signals is issued from remote processors to other remote processors that are associated with power demand sources.

Some embodiments may include overriding the power reduction command upon receipt of an override signal.

Some embodiments may include alternating the reduction in power demand between a first group of power demand sources and a second group of power demand sources at pre-defined periods during the period.

Some embodiments may include designating a first power demand source as part of the first group of power demand sources based on a level of power demanded by the first power demand source.

Some embodiments of the invention may include a system having a group of load control units that may each be associated with one or more power demand sources, where a first of such unit is to reduce power demand at a first power demand source and a second unit is to reduce power demand at a second power demand source, and where the system also includes a processor to (i) compare a power supply threshold to a total power demand level, (ii) calculate a reduction of power demand required to keep the total power demand from crossing the threshold, (iii) issue a signal to reduce power demand at the first power demand source during a first period, and issue a signal to reduce a power demand at the second power demand source during a second period, where the reduced power demand during the first period and during the second period is greater than the reduction of power demand required to keep the total power demand from crossing the threshold.

Some embodiments of the system may include a concentrator to receive a signal from the processor and to issue a signal to the first of group of load control units and to the second group of load control units.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a simplified diagram of components connected to an electricity network in accordance with an embodiment of the invention;

FIG. 2 is a diagram of effective timings of intermittent shut downs or load reductions of power demand sources in accordance with an embodiment of the invention;

FIG. 3 is a flow diagram of a method in accordance with an embodiment of the invention; and

FIG. 4 is a flow diagram of a method in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the embodiments of the invention.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating”, “comparing” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution result in a method of an embodiment of the invention. In some embodiments, one or more processors may perform one or more of the processes described herein, or more that one of such processes may be performed by a single processor.

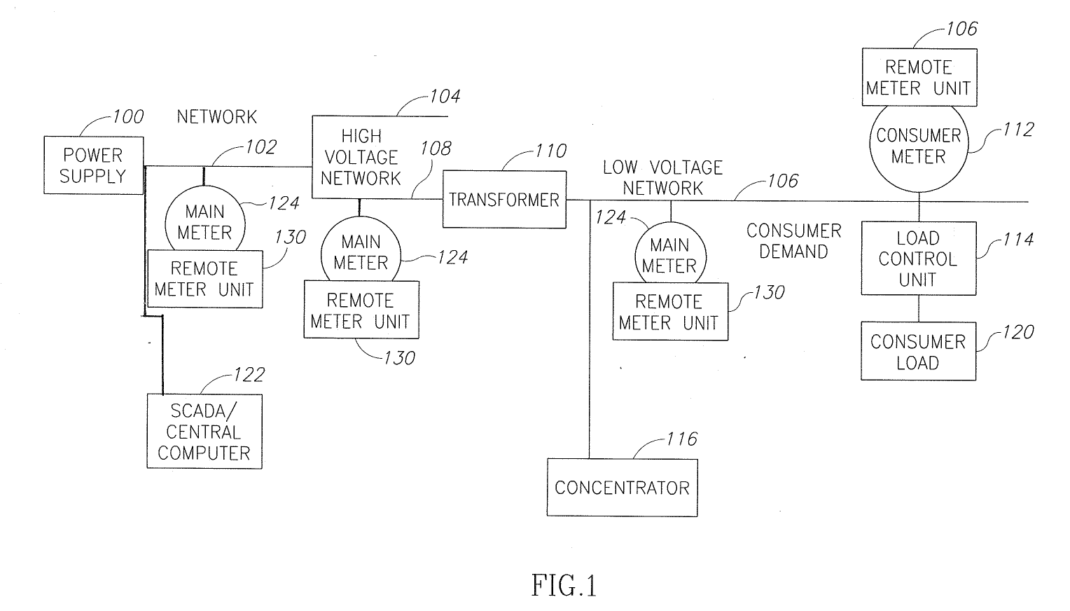

Reference is made to FIG. 1, a simplified diagram of components connected to an electricity network. In some embodiments a power supply 100 such as for example, one or more generators, turbines or other source of electric power may be connected to and supply electrical power over a network 102. Network 102 may include one or more sub-networks 104 that may include for example low voltage (LV) sub-networks 106, such as those that carry 110, 220 or other voltages, and high voltage (HV) sub-networks 108 such as those that carry 300 Kv or other voltages. In some embodiments, a transformer 110 may separate between an HV sub-network 108 and a LV sub-network 106.

In some embodiments, HV sub-network 108 may provide power to for example commercial and industrial (C&I) power users, while LV sub-network 106 may provide power to for example residential power users or other smaller power demand sources 120. In some embodiments one or more power demand sources may be fitted with one or more electric meters 112 and with one or more load control units 114 or other remote processors that may for example turn off or reduce a power supply to a power demand source 120 such as for example a residential air-conditioning unit, water heater or for example electrical appliances with for example power draw cycles. One or more main meters 124 may measure a power demand level of one, some or all of an LV sub-network 106, an HV sub-network 108 or for example some or all power demand sources on network 102. Main meters 124 may transmit demand data to for example one or more central computers 122, to other main meters 124 or to other components on the network 102 over for example a wide area network, telephone network, cellular network or the Internet.

In some embodiments a local concentrator 116 computer or remote processor may be installed or located along a low voltage network 106 power line that may connect to a few or several meters and load control units 114. Concentrator 116 may communicate and/or monitor power demand sources 120 via for example signals sent over the power lines that connect the concentrator 116 to the load control unit 114. Concentrator 116 may issue signals to one or more load control units 114 to reduce a draw of power from a power demand source 120 at a particular time and for a particular period. Concentrator 116 may issue signals to one or more other concentrators 116.

In some embodiments, a load control unit 114 may be connected to or in communication with a local meter 112, such as for example a meter that may monitor an electricity usage of a home or residence. A load control unit 114 may be suitable for turning off or reducing a power demand of one or more individual demand sources. For example, load control unit 114 may upon receipt of a signal from for example concentrator 116, turn off a compressor of an air conditioner or refrigerator, a water heater or other electrical appliance.

Network 102 may be connected to one or more SCADA (supervisory control and data acquisition) systems and/or central computers 122. Central computer 122 may among other things monitor power supply levels and power demand levels at various periods. Central computer 122 may also store data on power generation capacities of one or more power sources 100 such as generators, and may track which power supplies may be activated when a power demand level reaches a particular threshold. Central computer 122 may also communicate or send signals to one or more concentrators 116 or load control units 114. Such communication may be provided over cellular networks, TCP/IP networks, phone lines or other communication systems.

In operation, main meters 124 may track power demand information on a constant or periodic basis for one or more LV sub-networks 106 or HV sub-networks 108 or for an entire network 102, and may transmit such power demand information to central computer 122. Computer 122 may track power supply information. Computer 122 may calculate or compare a difference between a total power demand on a network 102 or sub network 108 and a total power supply still available from activated power supply sources 100. Before activating an additional or incremental power supply source 100, computer 122 may issue a signal to for example one or more concentrators 116 to reduce power demand at one or more power demand sources 120. In some embodiments, such signal may include a value or sum of the reduction in power demand required in order to avoid activating the incremental power supply source 100. Computer 122 or one or more concentrators 116 may evaluate a power demand reduction required over a particular period, and may signal one or more load control units 114 to intermittently turn off or reduce power demand from respective power demand sources 120 so that at all times during the relevant period, the total power demand of the demand sources 120 that are on is not above a pre-defined amount, and the total reduction of power demand from such demand sources 120 is at least a pre-defined amount. The length of the intermittent on/off cycles of load control units 114 may be determined for example by a required load reduction, a convenience or comfort factor of one or more users of the power, the existence of an emergency or other circumstances. For example, load control units 114 may at first shut off or reduce load so that at all times during the relevant period, at least 10% of the load is reduced on a rolling basis or intermittently among all or some of the loads that participate in the load reduction. Other sums may be used. If more load reduction is required, the periodicity or duration of shut downs or reductions may be increased so that at all times during the relevant period, 20% of the load is reduced or subject to reduction or otherwise exceeds a predefined sum of load or power demand.

In operation, one or more main meters 124 or computer 122 may predict power demand values for a future period, such as for example a next minute or number of minutes. If the predicted demand is calculated to reach a threshold upon which an incremental power supply source 100 will be needed, a signal may be issued to impose load reduction procedures.

In some embodiments, imposed load reductions may delay the need to activate a power supply source 100 by reducing power demand over a particular period to levels that may be served by power sources that are already activated. Similarly, cessation of power reduction measures once an incremental generator has been added may facilitate use and sale of all generated power.

In operation, once an incremental power supply source 100 has been activated, computer 122 may signal one or more concentrators 116 to cease power reduction measures so that all or a maximum of the power that is generated after activation of such incremental power supply source 100.

In some embodiments, computer 122 may include or be connected to processing capability, data storage capability and network communication capability, such as telephone, WAN, cellular and power line communication. In some embodiments, computer 122 may collect power supply information from power supply sources 100, may collect and monitor power demand information from concentrators 116 and remote monitoring units 130 that may monitor commercial and industrial power demand on for example HV sub-networks 106 and may synchronize timing of the other components of the system according the timing of the computer 122.

In some embodiments, computer 122 may collect power supply information from power supply sources 100, collect and classify specimen power demand characteristics or load profiles from demand sources, and may collect data from concentrators 116 and HV main meters of C&I consumers. The consumers' data may be classified for example according to residential, small business, government and other types of consumers. The central computer 122 may calculate the average data for consumers in the various classes and extrapolate the load profile to the rest of the class by multiplying the average data by the number of the class consumers. Aggregation of classes may provide an approximate load profile of parts or of the whole service area, which may be compared with a load profile achieved from SCADA or other sources of the utility. The central computer 122 may calculate the advisability of investing in demand reduction devices in the various demand sources to achieve the best results of demand reduction. For example, central computer 122 may simulate a level of demand reduction for a chosen class of demand sources, and display the reduction effect on the peak demand of the whole service area, giving the operator a visible tool for a demand reduction effort. The central computer 122 may also simulate which class is contributing the most to the system peak demand and may calculate, based on the power supply source data, if reducing for example a demand sources by a given level will be enough to reduce the whole service area peak demand below for example the emergency level of power production. Central computer 122 may also calculate which class has the lowest load factor during a specified time period, for example during the medium tariff period, and thereby provide data that may be used in a decision on investing in demand reduction efforts and on an optimized investment to reach a given level of demand reduction.

In some embodiments, concentrator 116 may include for example an embedded processor suitable to, among other functions, (i) transmit and receive signals over wireless or power line communication systems, (ii) receive signals from load control units or other remote monitoring units 130 on a LV sub-network 106, and (ii) synchronize timing of meters and units 130 according to its clock.

In some embodiments, a monitoring unit 130 may include for example an embedded processor suitable to, among other functions, (i) interface with a meter by way of for example pulses or RS232 protocols, (ii) communicate with other low voltage sub-network 106 components such as concentrators 116 and load control units 114, (iii) monitor or calculate power demand values and time of use figures at various periodicities, such as every 1, 5 or 15 minutes, and (iv) provide alert signals in the event power demand exceeds pre-defined thresholds.

In some embodiments, a high voltage remote meter unit 124 may include for example an embedded processor suitable to, among other functions, (i) enable communication capabilities over for example telephone, cellular or Internet, (ii) interface with a meter by way of for example RS232 protocols or other standards, (iii) communicate with other components on a high voltage sub-network 108 such as remote monitoring units and load control units 114, (iii) monitor or calculate power demand values and time of use figures at various periodicities, such as every 1, 5 or 15 minutes, and (iv) provide alert signals in the event power demand exceeds pre-defined thresholds.

Load control units 114 may connect, disconnect or reduce a power demand of one or more demand sources such as appliance with a duty cycle. Such actions may be performed in response to a receive signal over for example a power line or wireless communication network.

In some embodiments a load control unit 114 may be overridden by for example a user so that even though the load control unit 114 has received a load reduction signal, the user may dictate that one or more of his power demand sources 120 (such as for example his air conditioner) not be turned off or otherwise subject to load reduction. In some embodiments, such as during an emergency load reduction, a load control unit 114 may receive a mandatory reduction signal, by which it will be commanded to ignore or override a user's attempted override of a load reduction signal so that despite the user's instruction, his demand will be subject to the load reduction. In some embodiments an incentive may be provided to a user for not overriding a power reduction process. The remote monitoring unit (RMU) 130 may track power usage during the power reduction period any may signal by for example displaying to a user a reduction in customer power rates for participation in the demand reduction effort or for participation in certain designated periods. In some embodiments a user may be given a choice of which of his appliances to subject to a demand reduction process. For example, a user may choose to permit a power reduction process from applying to a water heater on a hot day, but may override a power reduction process from applying to an air conditioner on such day. The user may also increase his saving by informing the system by means of website, telephone call, special unit or some other means about his willingness to participate or increase his participation in demand reduction and to provide details such as specific times where he may be more or less willing to participate, and the system may provide the user with anticipated or actual savings from such participation. A user may thereby be able to evaluate the costs and benefits of participating or rejecting the demand reduction cycle.

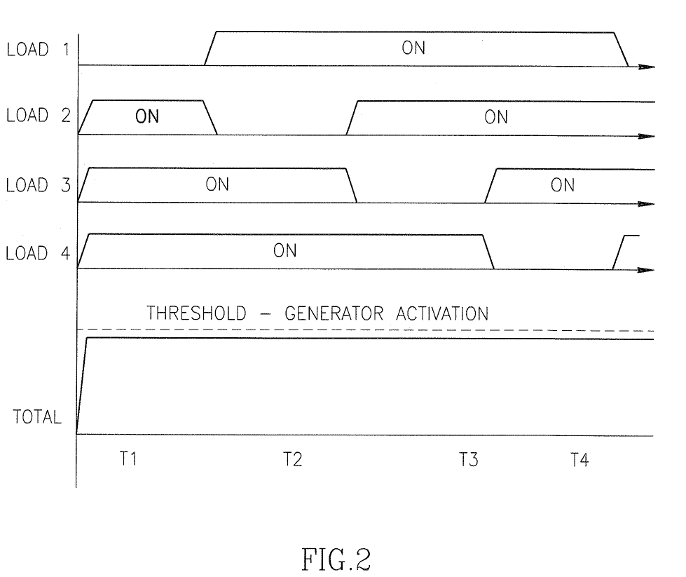

Reference is made to FIG. 2, a diagram of intermittent shut downs or load reductions of power demand sources in accordance with an embodiment of the invention. The diagram indicates that in some embodiments, a 25% load reduction during a relevant period may be achieved by for example synchronizing load reduction shut downs so that at least 25% of the load sources are shut down at all times. Other reduction rates may be used. For example, at time T1, loads 2, 3 and 4 may be on, while load 1 may be shut down. At T2, load 1, 3 and 4 may be on while load 2 is off. At T3, loads 1, 2 and 4 may be on, while load 3 is shut down, and at T4, loads 1, 2 and 3 may be on while load 4 is shut down or reduced. In some embodiments such a cycle of shut downs may be followed throughout a period or until a new calculation of required reduction values is signaled.

In some embodiments, a calculation of the number or duration of shut downs may also include a weighting of the loads to be shut down, so that shut down of a demand source having a higher load may take the place of for example a shut down of two demand sources having smaller loads. In some embodiments, synchronization of shut downs may be implemented over a particular period. For example, a one hour period may be divided into for example 12 time slots of five minutes each, and the various combinations of shut downs and ‘on’ periods may be successively activated in one or more of such slots.

In some embodiments, such as for example a large number of power demand sources 120, a random selection of loads to be shut down in any slot may be implemented on the assumption that the random shut down of such large number of loads will achieve the desired demand reduction.

In some embodiments an optimal or preferred duration for a shut down may be derived from a percentage of users who may override a shut down or power reduction process. For example a high percentage of users who choose to override a shut down process may be seen as an indication that the shut down was unduly inconveniencing users. Shut down durations may then be shortened until a smaller number of overrides are activated. A consumer inconvenience level (CIL) may be calculated as the maximum level of power reduction measures that a power network may activate in light of consumer tolerance for power shut downs. A CIL may be expressed as a duration of power shut downs, frequency of power shut downs or other extent or power reduction measures. In some embodiments, a CIL may be a function of inputs such as the day of week, the time of day, the temperature outside and other factors,

In some embodiments a demand threshold for the whole service area may be achieved by the central computer 122 simply as the value of the current power production capacity, and the central computer 122 will send reduction signal to all concentrators 116 with the required level of reduction when the demand approaches the current production level. In some embodiments, a threshold for power supply calculations may be derived manually, with data received from a SCADA or based on predictions and statistical data.

Alternatively or in addition, a demand reduction threshold may be calculated or imposed by one or more specific networks or sub-network 106s, thereby enabling dispersed rather than centralized load reduction efforts. Such dispersed or diffused efforts managed by one or more concentrators 116 in respect of the sub-networks 106 that they control may reduce the amount of signals that must be transmitted from central computer 122 to concentrators 116, and may increase the robustness of the demand reduction efforts.

For example, a concentrator 116 may be loaded with, or may collect, data from various sources such as low voltage main remote meter unit 130 and 124 to establish a load profile of its network. When the central computer 122 sends a signal to initiate a demand reduction effort, the concentrator may impose demand reductions based on the usage data that it has stored or collected, and such reductions may be instituted without direct instructions from central computer 122 as to which loads to reduce and for what period. A concentrator 116 or other remote processor may rely on its collected or stored demand usage data to independently determine how to implement reduction processes. Dispersed threshold calculations may also be based on statistical data and may be done by concentrator 116 or remote monitoring unit 130. For example concentrator 116 or high voltage remote monitoring unit 130 may read the maximum low tier sub-network total demand, in for example March or other low demand season when for example the sub-network maximal demand may be 50 MW. The statistic information is concerning the whole service area and may indicate that the highest total demand in a low tier and in such low season is for example 1 Gigawatt (GW). Assume further that the highest demand season is July, when the maximal low tier demand is approximately twice the low season, or in this case 2 GW. In that case the system may assume that a power producer would activate an incremental generator when the whole service area demand reaches 2 GW, or twice the March level. Concentrator 116 may use this information to determine that low tier threshold is twice the threshold one measured in March, or in this example 100 MW for this specific sub-network

In some embodiment central computer 122 may store data on an entire service area demand threshold (DT) per power production stage (PS) for each successive activation of turbines. In that way it may keep an array of demand threshold values per production stage (DT(PS)). Similarly, a concentrator 116 or high voltage remote monitoring unit 130 may store and keep such DT(PS) array of demand thresholds per production stage for any particular high voltage and low voltage sub-network.

In some embodiments, computer 122 may issue a signal to one or more concentrators 116 or other remote processors, and such concentrators 116 may relay such signal or a part thereof to other concentrators 116. This chain reaction of signals may allow almost simultaneous broadcast of power reduction signals over a system that may not support point-to-multipoint transmissions.

In some embodiments, computer 122 or some other processor may receive or collect data that may include current power supply capability (CPSC), total power supply capability (TPSC), and whole area current demand (WACD). Computer 122, concentrator 116 and units 130 may also store data on the time required for signal distribution (TRSD) and execution of a command for power reduction procedures. Computer 122 may do that for the whole service area while concentrator and unit 130 may perform this function for their sub-networks. Computer 122 or other computers may also issue signals to start power demand reduction to postpone generator activation or to deactivate a working generator, or to stop power demand reduction when such reduction is no longer required.

Computer 122 may on the basis of for example real time readings from meter 124, periodically calculate a power demand increase speed (change in demand over time) (DIS) as a prediction of the rate of increase of demand for power on network 102 over a particular period. DIS may be calculated as an average network demand speed (ANDS) between two or more current network demand speeds (CNDS) when each CNDS is a difference between 2 successive current network demand (CND) readings from for example meters 112 or unit 130, divided by the time between readings. Increasing demand may be characterized by DIS>0, while decreasing demand may be characterized by DIS<0.

An estimated next network demand (ENND) at a particular future time may be expressed as CND+DIS*T, T for example equal 15 minutes. Specifically for example if ENND is CND+(DIS*TRSD)>=DT(PS), where TRSD is the time required for signal distribution, then demand reduction procedures may be initiated by concentrator.

Computer 122 may issue a signal to start power reduction procedures if WACD+(DIS*TRSD)≧CPCS. Computer 122 may issue a signal for emergency power reduction procedures if WACD+(DIS*TRSD)≧TPSC.

In a period of decreasing demand, power reduction procedures may be initiated if (1−CIL)*ENND≦DT(PS−1), which is to say that if a level of power reduction is achievable within a utility's policies is enough to hasten the deactivation of a generator by bringing power demand beneath a next power supply threshold, then such power reduction procedures will be initiated.

In some embodiments a disconnect or power reduction cycle may be implemented on pre-designated groups of load demand sources. For example, if a 25% reduction in power demand is required during a 20 minute period, then for example four groups of demand sources may be designated, where each group may include approximately equal load values. In the 20 minute cycle, each group may be subject to load reduction for successive five minute period, so that over the 20 minute period, each group has been ‘off’ for one 5 minute period and ‘on’ for the remainder of the period, without overlap of off periods among the groups. If additional power load reductions are required in the middle of a cycle, it may be preferable to add other power sources to the cycle rather than repeat an ‘off’ period for a group that has already sustained a reduction in a particular cycle.

In some embodiments the duration of a power reduction or ‘off’ period may be dictated by among other things the power sources that are being turned off. For example, efficiency of domestic air conditioners may be impaired if they are turned on and off within a short period. Commercial or industrial air conditioners may be better controlled by mandated changes to thermostats over particular periods.

In some embodiments, a demand may be managed in cycles where during the current cycle (CC) choice of loads to be disconnected depends on the reduction capacity (RC) that may be some predefined fraction of all loads, the already used loads (AUL) and the minimal required reduction MRR. The RC may be defined as a part of the total network load by a manageable factor (MF) that determines how much of all loads are connected to the load control units (LCU) 114 and therefore may be disconnected commanding a reduction process. For example MF=0.5 means that 50% of the loads are connected to LCU 114. For example at the beginning of a current cycle MF may be initialized to 0, CC=0 the current reduction ratio (CRR), which defines what should be the reduction ratio in CC and ALU will be set also to 0. At the start of the reduction cycle, an estimate of current reduction capacity (CRC) may be calculated as MF ratio of the total of all loads connected to load control units 114 that are currently contributing to the current network demand (CND) but excluding the loads that are or have already been subject to shut down in the current reduction cycle, or CRC=CND*MF-AUL. A computer 122 may calculate the minimum required reduction (MRR) to remain within the threshold which means that expected demand after taking into account the current reduction and the change in demand during the current period will still be below the threshold to satisfy the condition END−CRC*MRR=<DT(PS), which results in MRR=(END−DT(PS))/CRC. Computer 122 may before starting a new reduction cycle, check the incremental power generation to determine if an additional power supply source has been initiated and to send a signal to concentrators 116 and units 130. In that case the CND may be set as the demand threshold for the current cycle such that DT(PS)=CND, the PS may be incremented and all power reduction processes may be stopped.

If the MRR for the manageable capacity exceeds the consumer inconvenience level (CIL), such that (END−DT(PS))/CND>CIL then the current power reduction processes may be continued as long CND>DT(PS), until an incremental generator is activated, upon which reduction processes will be terminated.

If no signal for a stop in reduction processes is received, but there is not sufficient reduction capacity available to the system under regular conditions, but there is reduction capacity available if reduction is implemented for loads that were already subject to reduction in the current cycle, then the required reduction capacity may be achieved by re-using such AULs, such that if MRR>CIL, then set AUL=0, increment the current cycle, and proceed to the power reduction process that will re-use the AULs.

If no new reduction capacity is required, evaluate if MRR≠PMRR, then signal LCU's to initiate another reduction cycle where cycle time (CT)=minimum disconnect time (MDT)/MRR. The number of time slots (NTS)=1/MRR, and time to start disconnections (TSD) may be the current time plus the lag time needed for distribution of power reduction signals and implementation of the reduction commands. For example, if MDT is 5 minutes and MRR is 0.1 or a 10% reduction that is required, then CT may be 50 minutes and NTS may be 10.

Upon receiving a power reduction signal, an LCU may check an internal cycle number (ICN) of the signal to make sure that the signal indicates a start of a new reduction cycle. If the ICN is >current cycle (CC), the LCU may choose a time slot of its power reduction disconnect. Such time slot may be for example an internal ID number of the LCU modulo the number of NTS or may be based on some other selection method.

Computer 122 may update an AUL parameter after issuing a reduction signal, where a new AUL=AUL+CRC*MRR. Computer 122 may also check the actual reduction and update the manageable factor (MF), compute the demand after reduction (DAR) and achieved demand reduction (ADR)=CND−DAR. The expected reduction (ER) may be calculated as (CND*MF−AUL)*MRR. A real, achieved demand reduction ADR=(CND*RealMF−AUL)*MRR so the RealMF may be calculated as (ADR+AUL*MRR)/(CND*MRR). Computer 122 may update MF and AUL values and repeat a process of checking END and PS(DT).

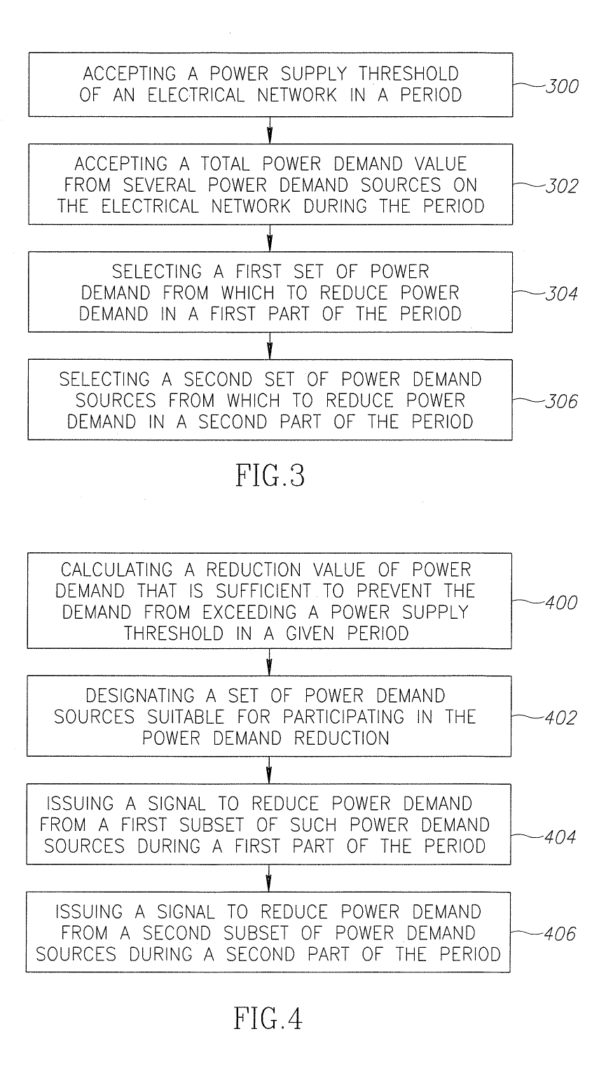

Reference is made to FIG. 3, a flow diagram of a method in accordance with an embodiment of the invention. In block 300, there may be accepted a power supply threshold of an electrical network in a particular period, where the threshold may be the power supply that may be maintained by the currently operating power supply generators. In block 302 there may accepted a total power demand value from several power demand sources on the electrical network during the period, and such demand may represent the total power being demanded on a network or a part of a network. In block 304, a processor may select a first set of power demand sources from which to reduce power demand in a first part of the period, and in block 306, a processor may select a second set of power demand sources from which to reduce power demand in a second part of the period. As a result of the reduction of the total power demand achieved in the first part of the period, total power demand is prevented from crossing the power supply threshold during such first part of the period. As a result of the reduction of the power demand achieved in the second part of the period, the total power demand is prevented from crossing the power supply threshold during the second portion of the period.

Reference is made to FIG. 4, a flow diagram in accordance with an embodiment of the invention. In block 400 a calculation may be made of a reduction value of power demand that is sufficient to prevent the demand from exceeding a power supply threshold in a given period. In block 402, a set of power demand sources suitable for participating in the power demand reduction may be designated. In block 404 a signal may be issued to reduce power demand from a first subset of such power demand sources during a first part of the period. In block 406, a signal may be issued to reduce power demand from a second subset of the power demand sources during a second part of the period. A result of the reduction in power may be that power demand during the entire period is at least equal to the reduction value.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

I claim:

1. A method of altering a sum of power demanded on an electrical network comprising:
accepting a power supply threshold of an electrical network in a period;
accepting a total power demand value of said electrical network in said period;
selecting a first portion of a plurality of power demand sources from which to reduce power demand in a first portion of said period;
selecting a second portion of said plurality of said power demand sources from which to reduce power demand in a second portion of said period;
wherein a reduction of said total power demand achieved from said reducing in said first portion is sufficient to prevent said total power demand value from crossing said power supply threshold during said first portion of said period; and
wherein a reduction of said total power demand achieved from said reducing in said second portion is sufficient to prevent said total power demand value from crossing said power supply threshold during said second portion of said period.

2. The method as in claim 1, further comprising predicting a total power demand value for said period.

3. The method as in claim 2, wherein said predicting comprises measuring a change in power demand at a plurality of times during a period prior to said period.

4. The method as in claim 1, wherein said accepting said power supply threshold comprises accepting said threshold for activating an additional power supply, and further comprising:
issuing a signal to cease said reductions of said total power demand upon said activation of said additional power supply.

5. The method as in claim 1, wherein said accepting said power supply threshold comprises accepting said threshold for deactivating a power supply source.

6. The method as in claim 1, further comprising preventing in said first portion of said period a reduction in power demand from a power demand source of said first portion of said plurality of power demand sources for which an override signal has been received.

7. The method as in claim 6, further comprising issuing a signal to override said override signal upon the satisfaction of a pre-defined condition.

8. The method as in claim 6, further comprising displaying to a user a cost of said preventing.

9. The method as in claim 1, further comprising issuing a first signal to a remote processor to reduce power demand in said first portion of said plurality in said first period, and issuing a second signal from said remote processor to a plurality of other remote processors to reduce power demand in said first portion of said plurality in said first period.

10. The method as in claim 9, wherein issuing said second signal comprises issuing a signal to a load control unit associated with a power demand source in said first portion of said plurality of power demand sources.

11. The method as in claim 1, wherein said plurality of demand sources comprises a first plurality, and further comprising simulating a second plurality of demand sources from which to select said first portion of said first plurality of power demand sources from which to reduce power demand in a first portion of said period.

12. The method as in claim 11, further comprising identifying said second plurality of demand sources prior to said selecting of said second portion, as having sufficient power demand reduction capacity to prevent said total power demand value from crossing said power supply threshold during said first portion of said period.

13. The method as in claim A1, wherein said accepting a total power demand value of said electrical network in said period, comprises accepting a total power demand value from a portion of said electrical network in said period, said portion of said electrical network comprising a portion monitored by a single concentrator.

14. A method comprising:
calculating a reduction value of power demand, said reduction value sufficient to prevent said power demand from exceeding a power supply threshold in a period;
designating a plurality of power demand sources suitable for power demand reduction;
issuing a signal to reduce power demand from a first group of said power demand sources in said plurality during a first part of said period; and
issuing a signal to reduce power demand from a second group of power demand sources in said plurality during a second part of said period;
wherein during said period said reduced power demand is at least equal to said reduction value.

15. The method as in claim 14, further comprising predicting said demand value for said first part of said period.

16. The method as in claim 14, further comprising receiving at a first remote processor said signal to reduce power demand from said second group of power demand sources, and issuing from said first remote processor, a signal to a second remote processor and to a third remote processor, said second remote processors associated with a first power demand source of said second group of power demand sources, and said third remote processor associated with a fourth remote processor and a fifth remote processor, wherein said fourth remote processor is associated with a second power demand source of said second group of power demand sources, and said fifth remote processor is associated with a third power demand source of said second group of power demand sources.

17. The method as in claim 14, further comprising avoiding said reduction of power demand at a power demand source in said first group for which an override signal is received.

18. The method as in claim 14, further comprising alternating said reduction in power demand between said first group of said power demand sources and said second group of said power demand sources at pre-defined periods during said period.

19. The method as in claim 14, further comprising designating a first power demand source as part of said first group of said power demand sources based on a level of power demanded by said first power demand source.

20. A system comprising:
a plurality of load control units, a first unit of said plurality to reduce power demand at a first power demand source and a second unit of said plurality to reduce power demand at a second power demand source;
a processor suitable to:
compare a power supply threshold to a total power demand level;
calculate a reduction of power demand required to keep said total power demand from crossing said threshold;
issue a signal to reduce power demand at said first power demand source in a first period; and
issue a signal to reduce a power demand at said second power demand source in a second period,
wherein said reduced power demand during said first period and said second period is greater than said reduction of power demand required to keep said total power demand from crossing said threshold.

21. The system as in claim 20, wherein said processor is to calculate a prediction of said total power demand during said first period and said second period.

22. The system as in claim 20, further comprising a concentrator to receive said signal from said processor and to issue a signal to said first of said plurality of load control units to reduce said power demand at said first of said power demand sources, and to issue a signal to said second of said plurality of load control units to reduce said power demand at said second of said power demand sources.

23. The system as in claim 22, wherein said first load control unit is suitable to avoid said reducing of power demand upon receipt of a an override signal.

24. The system as in claim 20, comprising a meter to collect a power demand value at a plurality of times during said first period and said second period, and to transmit said power demand value to said processor.
